(19) United States
(12) Patent Application Publication
(10) Pub. No.: US 2016/0239401 A1
(43) Pub. Date: Aug. 18, 2016

(54) BLACK-BOX SOFTWARE TESTING WITH STATISTICAL LEARNING

(71) Applicant: FUJITSU LIMITED, Kawasaki-shi (JP)

(72) Inventor: Guodong LI, San Jose, CA (US)

(21) Appl. No.: 14/623,399

(22) Filed: Feb. 16, 2015

(51) Int. Cl. G06F 11/36

(52) U.S. Cl. CPC G06F 11/3608

(57) ABSTRACT

A method to determine a relationship between inputs and outputs based on a parametric model may include receiving a data set that includes known inputs and corresponding known outputs associated with a component. The method also includes generating a parametric model to automatically determine a functionality of the component based on the data set by selecting the parametric model from multiple types of parametric models based on a data type associated with the data set. The method also includes determining whether the parametric model applies to the data set. The method also includes, responsive to determining that the parametric model applies to the data set, receiving a new output associated with the component. The method also includes determining a new input from the new output based on the parametric model.

### FIELD

The embodiments discussed herein are related to black-box software testing with statistical learning.

### BACKGROUND

Software testing, such as validating or verifying software, is a common activity among information technology (IT) organizations. For example, the software may include a desktop application for execution at one or more client computer systems or a web application for execution at one or more server computer systems. In either case, it may be important to verify the quality of the software. While some types of errors in software cause only annoyance or inconvenience to users, other types of errors include a potential to cause more serious problems, such as data and financial loss.

A software component may be associated with unknown functionality. Applying inputs to the software component may result in outputs, but the functionality that causes an input to result in a corresponding output may be unknown. The process of trying to determine the functionality of the software component may be referred to as “black-box software testing” and the software component may be referred to as a “black-box component.”

Determining the functionality of the black-box component may be difficult if the black-box component includes proprietary software (e.g., closed-source software) with code that is unavailable for analysis. In addition, the black-box component may be machine dependent, encrypted, or unavailable based on a security policy. The functionality of the black-box component may be determined from a specification or through random testing. However, different testing methodologies often involve a human tester, which slows down the testing process and increases costs associated with software testing. In addition, random testing may produce inaccurate and/or incomplete results.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method to determine a relationship between inputs and outputs based on a parametric model may include receiving a data set that includes known inputs and corresponding known outputs associated with a component. The method also includes generating a parametric model to automatically determine a functionality of the component based on the data set by selecting the parametric model from multiple types of parametric models based on a data type associated with the data set. The method also includes determining whether the parametric model applies to the data set. The method also includes, responsive to determining that the parametric model applies to the data set, receiving a new output associated with the component. The method also includes determining a new input from the new output based on the parametric model.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 illustrates an example block diagram representing an example test system configured to perform black-box testing of a component with unknown functionality;

FIG. 2 illustrates an example device to perform black-box software testing with statistical learning;

FIG. 3 illustrates a flowchart of an example method to test a component with unknown functionality;

FIGS. 4A-4B illustrate a flowchart of an example method to generate a parametric model for the component of FIG. 3; and

FIG. 5 illustrates a flowchart of an example method to relate known inputs and corresponding known outputs for the component of FIG. 3 without assuming a specific model.

### DESCRIPTION OF EMBODIMENTS

Several methods to test and verify a component with unknown functionality exist. For example, statistical learning creates numerical models for several domains including healthcare and finance. However, the component may use more complicated data types than a numerical model. As a result, current statistical learning methods may include limited applicability. In another example, program synthesis uses a specification or data to test software. However, program synthesis fails to make inferences about unknown parts of the software. In yet another example, string relation inference infers a subset of string operations from data. However, the subset of string operations may be of limited utility and the program synthesis may be not able to be incorporated into a larger application.

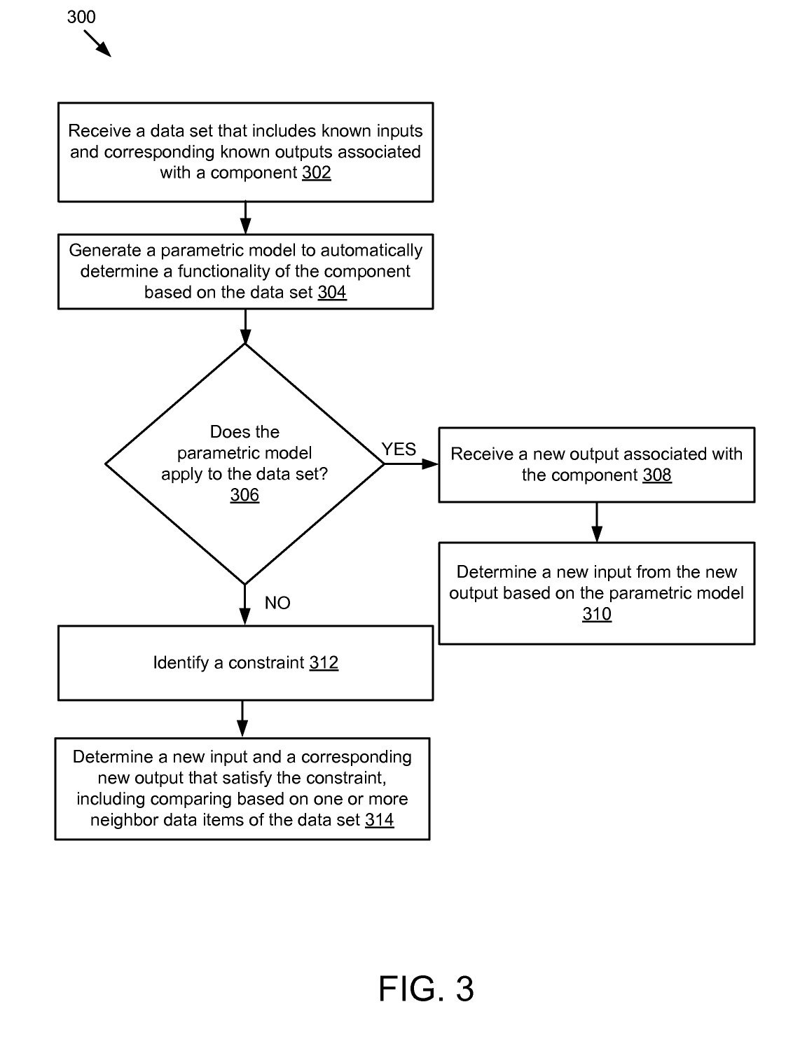

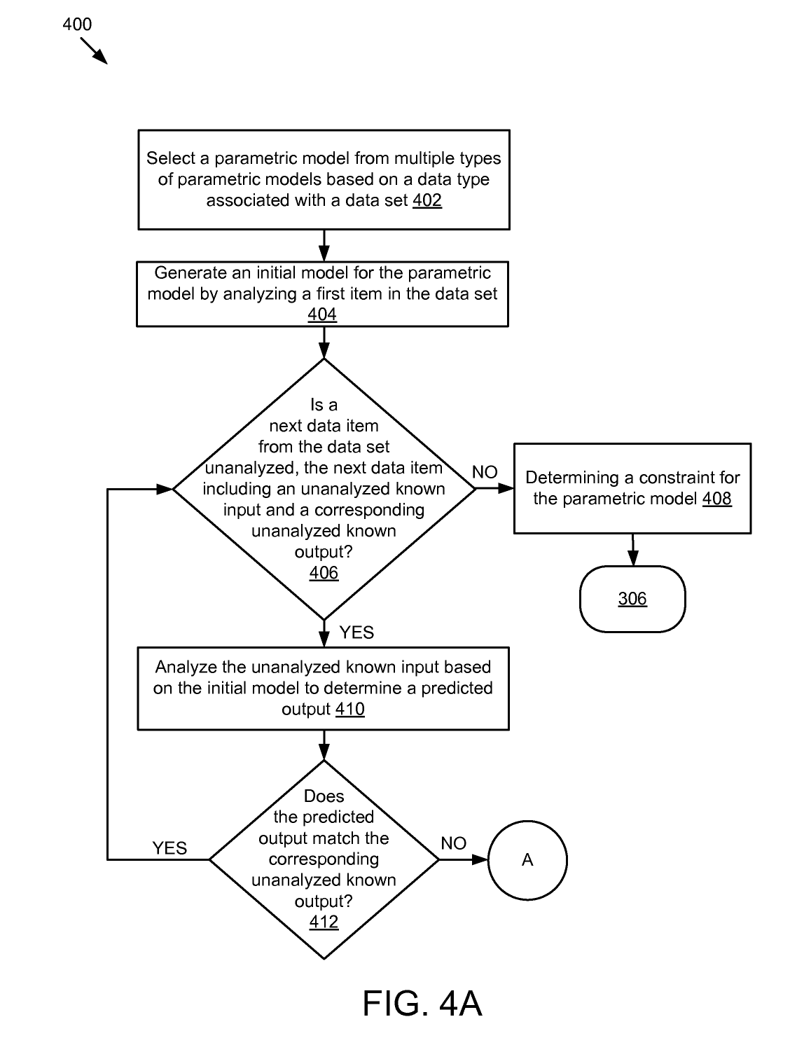

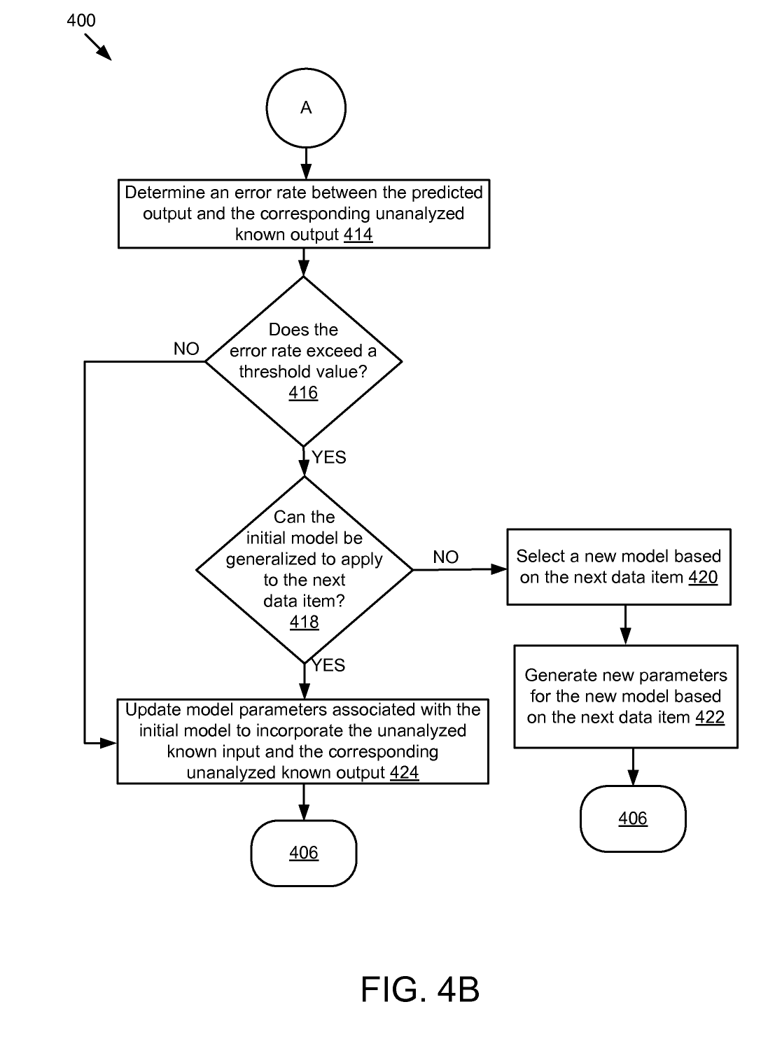

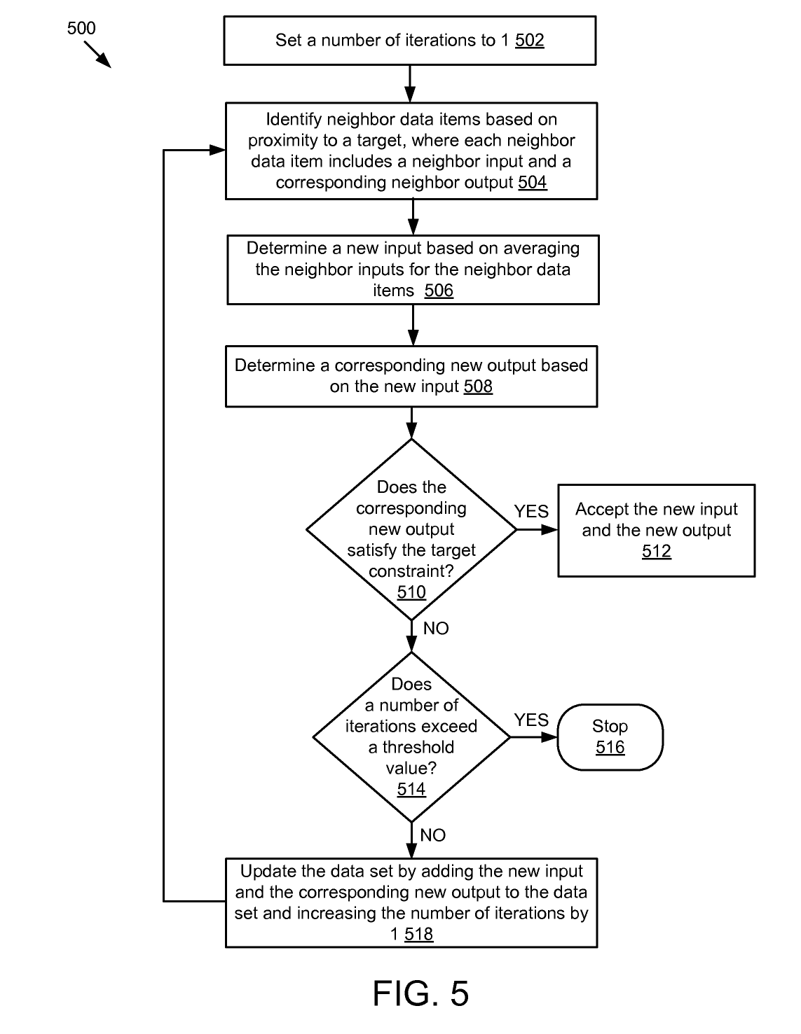

The deficiencies of these and other systems may be overcome by a test system that performs black-box software testing with statistical learning as described herein. The test system described herein may include a computing device. For example, the test system may include a personal computer, laptop, tablet computer, server or any processor-based computing device. The test system may include a memory and a processor device. The processor device may be programmed to perform or control performance of one or more operations described herein, such as one or more operations or steps of a method 300, 400, and 500 described below with reference to FIG. 3, FIGS. 4A-4B, and FIG. 5, respectively. One or more example embodiments of the test system are described below.

The test system may include a test application that receives a data set that includes known inputs and corresponding known outputs associated with a component with unknown functionality. The component may include a function within a class, a class within a package, a module, a piece of binary code, a piece of machine code, a third-party closed-source library, a database, a server, or any combination thereof. The data set may include, for example, data items with a primitive data type or a non-primitive data type.

The test application may generate a parametric model based on the data set. In these and other implementations, the test application may select the parametric model from multiple types of parametric models based on a data type associated with a data set. For example, the test application may select a regular expression model based on the data type for the data set including strings. The test application may perform statistical learning by using the data set to refine the parametric model. For example, the test application may generate an initial model for the parametric model by analyzing a first item in the data set. For example, the test application may generate an extraction regular expression where the parametric model is the regular expression model. The test application may analyze a next data item from the data set by analyzing an unanalyzed known input based on the initial model. The test application may update parameters for the initial model or generate a new model based on analyzing the unanalyzed known input. For example, for the regular expression model, the test application may revise the extraction regular expression or generate a new extraction regular expression that applies to the next data item.

If the parametric model fails to apply to the data set, the test application may implement a non-parametric method that relates known inputs and corresponding known outputs without assuming a specific model. For example, the non-parametric model may identify a constraint and determine a new input and a corresponding new output that satisfy the constraint based on one or more data items of the data set. The non-parametric method may include a K-nearest neighbor regression that identifies a K number of neighbor data items based on proximity to a target, determines a new input based on averaging neighbor inputs that are part of the neighbor data items, and determines a corresponding new output based on the new input.

The corresponding new output may be compared to a constraint. If the corresponding new output satisfies the constraint, the corresponding new output may be accepted. Otherwise, the new input and the corresponding new output may be added to the data set and the K-nearest neighbor regression may be performed iteratively until an updated new output is accepted or until a number of iterations exceeds a threshold value.

As a result of performing black-box software testing, a functionality of a component with unknown functionality may be determined automatically. In addition, the test application may derive inputs for a future state space of the component. The test application may be scalable with low overhead, may be accurate, and may be capable of analyzing both structured and unstructured code. The test application may be incorporated into other software applications to handle third-party closed-source code, function as part of a server, be used as a general method for data analysis, etc.

Embodiments of the present invention will be explained with reference to the accompanying drawings. With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

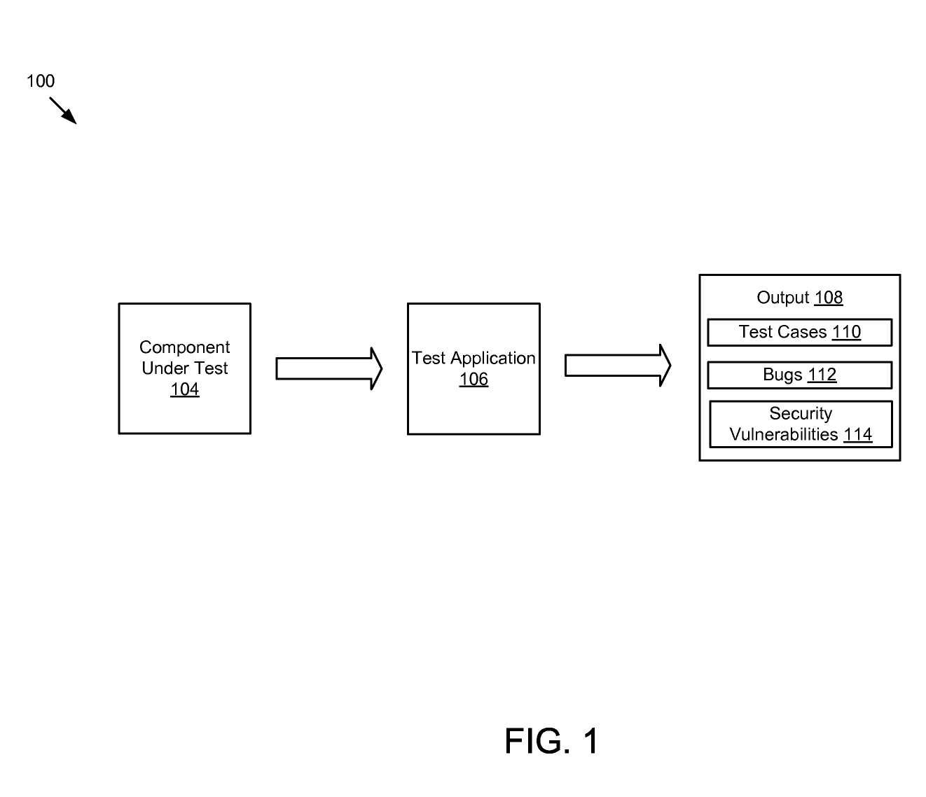

FIG. 1 illustrates an example block diagram representing an example test system 100 configured to perform black-box testing of a component with unknown functionality, arranged in accordance with at least one embodiment described herein. The test system 100 described herein may include a computing device. For example, the test system 100 may include a personal computer, a laptop computer, a tablet computer, a server computer or any processor-based computing device. The test system 100 may include a memory and a processor device. The processor device may be programmed to perform or control performance of one or more operations described herein, such as one or more operations or steps of the method 300, 400, and 500 described below with reference to FIG. 3, FIGS. 4A-4B, and FIG. 5, respectively. One or more example implementations of the test system 100 are described below.

The test system 100 may include a test application 106 configured to perform black-box software testing of a component under test 104 to generate output 108. The component under test 104 may include electronic data, such as, for example, a software program, code of the software program, libraries, applications, scripts, or other logic or instructions for execution by a processor device.

In some embodiments, the component under test 104 may include a complete instance of a software program. In these or other embodiments, the component under test 104 may include a portion of the software program. The component under test 104 may be written in any suitable type of computer language, such as Java, C, C++, Pearl, Scheme, Python, among others.

In some embodiments, the test application 106 may be configured to receive input and generate the output 108 from testing the component under test 104. The input may include primitive data types, non-primitive data types, or both primitive and non-primitive data types. For example, the input may include a string, a list, numbers, etc. The output 108 may include test cases 110 that reveal a functionality of the component under test 104, or bugs 112 and security vulnerabilities 114, which may be targets. After the test application 106 performs the parametric and/or non-parametric methods described below and generates the test cases 110, the test application 106 determines inputs and/or outputs to be given to the component under test 104 to achieve the targets of the bugs 112 and/or the security vulnerabilities 114.

In some embodiments, the test application 106 may generate one or more solutions for one or more sets of constraints if the constraints are satisfiable. In some embodiments, solving a set of constraints may include attempting to find one or more solutions that satisfy all the constraints included in the set. In some of these embodiments, the test application 106 may include the solutions with the output 108. In some embodiments, the solutions may be used to test the component under test 104.

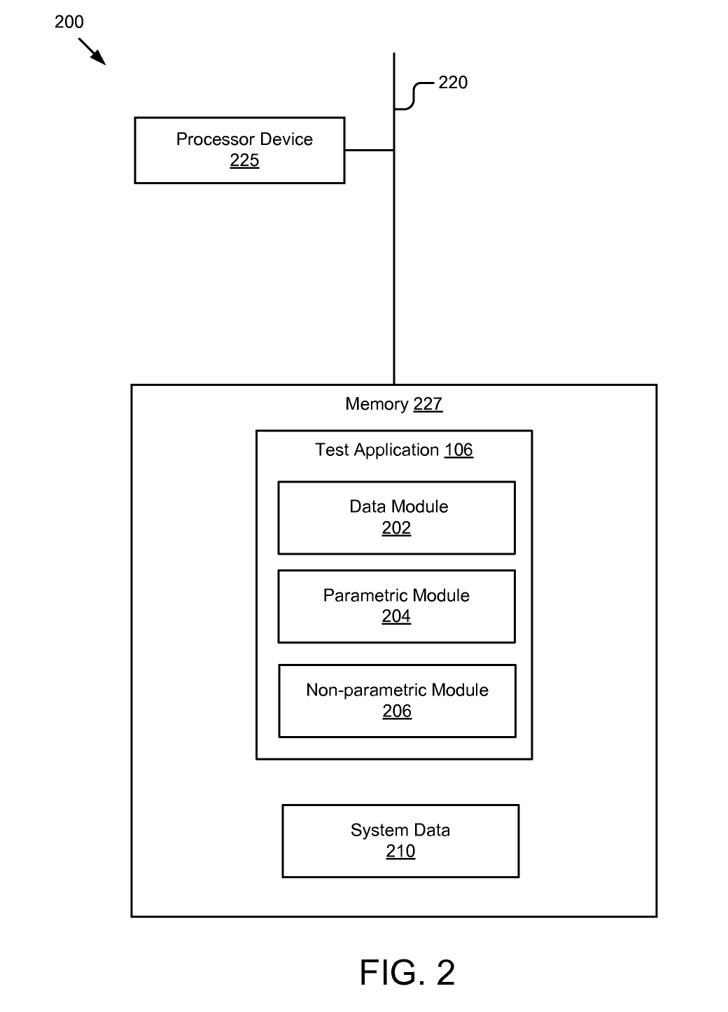

FIG. 2 illustrates an example device 200 to perform black-box software testing with statistical learning, arranged in accordance with at least one embodiment described herein. The device 200 of FIG. 2 may be an example of hardware used by the black-box software test system 100 described above with reference to FIG. 1. The device 200 may include a special purpose processor-based computing device programmed to perform one or more blocks of the methods 300, 400, and 500 described below with reference to FIG. 3, FIGS. 4A-4B, and FIG. 5, respectively.

The device 200 may include a processor device 225 and a memory 227. The processor device 225 may include an arithmetic logic unit, a microprocessor, a general-purpose controller, or some other processor or processor array to perform or control performance of operations as described herein. The processor device 225 processes data signals and may include various computing architectures including a complex instruction set computer (CISC) architecture, a reduced instruction set computer (RISC) architecture, or an architecture implementing a combination of instruction sets. Although FIG. 2 illustrates a single processor device 225, the device 200 may include multiple processor devices 225. Other processors, operating systems, and physical configurations may be possible.

The memory 227 stores instructions or data that may be executed or operated on by the processor device 225. The instructions or data may include programming code that may be executed by the processor device 225 to perform or control performance of the operations described herein. The memory 227 may include a Dynamic Random Access Memory (DRAM) device, a Static Random Access Memory (SRAM) device, flash memory, or some other memory device. In some embodiments, the memory 227 also includes a non-volatile memory or similar permanent storage and media including a hard disk drive, a floppy disk drive, a Compact Disc-ROM (CD-ROM) device, a DVD-ROM device, a DVD-RAM device, a DVD-RW device, a flash memory device, or some other mass storage for storing information on a more permanent basis.

In the depicted embodiment, the memory 227 may store one or more of the test application 106 of FIG. 1 and system data 210. In some embodiments, the test application 106 may be implemented using hardware including a field-programmable gate array (FPGA) or an application-specific integrated circuit (ASIC). In some other embodiments, the test application 106 may be implemented using a combination of hardware and software.

The test application 106 may include a data module 202, a parametric module 204, and a non-parametric module 206. While the modules 202, 204, and 206 are illustrated as being stored on one device 200, the modules 202, 204, and 206 may be stored on different devices, for example, in a distributed data system.

The system data 210 may include data used by the device 200 to provide its functionality. For example, the system data 210 may include one or more of a data set collected by the data module 202, a parametric model generated by the parametric module 204, components with unknown functionality, new inputs, and new outputs. Alternatively or additionally, the system data 210 may include any of the data described above with reference to FIG. 1. The various components of the device 200 (e.g., the processor device 225 and the memory 227) may be communicatively coupled to one another via a bus 220.

The various modules 202, 204, 206 of the test application 106 will now be described in more detail. The data module 202 may generally be configured to receive a data set that includes known input and corresponding known outputs. For example, the data module 202 may collect historical data by collecting input and output data from a component with unknown functionality.

The known input and corresponding known output from the data set may include primitive data types, non-primitive data types, or both primitive and non-primitive data types. For example, the primitive data type may include characters, integers, floating-point numbers, fixed-point numbers, Boolean, byte, short, etc., depending on the programming language used to create the component. Non-primitive data types may include strings, lists, vectors, heaps, pointers, etc.

In some embodiments, multiple inputs may be received. For example, Table 1 illustrated below includes example known inputs and corresponding known outputs for a data set. The data set is used in a regular expression model for strings that is described in greater detail below with reference to the parametric module 204. Each row in the data set may be referred to as a data item. Thus, a data item may include one or more known inputs and one or more corresponding known outputs.

TABLE 1
Data Set for a Regular Expression Model

| Input | Input | Output |
|---|---|---|
| s0 | s1 | s0′ |
| “A A” | “Abc Bc” | “BA0” |
| “A12 Bcd” | “Ac Bc” | “BA0” |
| “D Bcd” | “B_C” | “CD0” |
| “D_” | “C0” | “CD0” |
| “a aB” | “aCDe” | “B” |
| “c A” | “” | “A” |
| “b C” | “12 D” | “C” |
| . . . | . . . | . . . |

The data module 202 may combine the known inputs and the corresponding known outputs in Table 1 to create a data set. The data module 202 may save the data set as system data 210 stored in the memory 227.

The data module 202 may also update the data set after receiving data from the parametric module 204 and/or from the non-parametric module 206. For example, the non-parametric module 206 may use a K-nearest neighbor regression to generate new input and corresponding new output. The non-parametric module 206 may transmit the new input and the corresponding new output to the data module 202, which new input and corresponding new output the data module 202 may add to the data set.

The parametric module 204 may generally be configured to generate a parametric model based on a data set received by the data module 202. The parametric module 204 may receive the data set from the data module 202 or retrieve the data set from the memory 227. The parametric module 204 may determine whether the parametric model applies to the data set. For example, the parametric module 204 may use known input from the data set to determine a predicted output and may compare the predicted output to a corresponding known output that corresponds to the known input. If the predicted output matches the corresponding known output, the parametric module 204 may continue to analyze unanalyzed data items from the data set until all known inputs and corresponding known outputs are analyzed.

If predicted outputs continue to match corresponding unanalyzed known outputs from the data set (i.e., the corresponding known outputs), the parametric module 204 may determine at least one constraint for the parametric model based on the parametric model. This constraint describes the condition under which the known outputs are produced over the corresponding known inputs.

If the predicted output fails to match corresponding unanalyzed known output, the parametric module 204 may calculate an error measurement between the predicted output and the corresponding unanalyzed known output. The parametric module 204 may calculate the error measurement by determining a cost function based on string distance. The parametric module 204 may determine a distance calculation by using character range automaton to model string values, representing string constraints using automata, and calculating a distance by matching the string value with the automaton and counting a number of transitions to an accept state. For example, “s.startsWith(“A1”) [symbol] s.endsWith(“B2”) represents a string constraint using automata. The distance calculation for s=“A1” may be 0, the distance calculation for s=“B” may be 1, and the distance calculation for S=“C12” may be 2.

Similarly for regular expressions, the parametric module 204 may determine a distance calculation by using character range automaton to model the regular expressions, and calculate a distance by matching a string value with an automaton and counting a number of transitions to an accept state. Table 2 includes example distance calculations for a regular expression model consistent with the foregoing discussion.

TABLE 2
Example Distance Calculations for a Regular expression model

| regular expression | string value | Distance |
|---|---|---|
| a[0-9]A | a1A | 0 |
| a[0-9]A | A!a | 2 |
| [A-Z](!\|@)[a-z] | A!1 | 1 |
| \w[0-9]+ | 000 | 2 |

If the parametric module 204 determines that the parametric model applies to the data set, the parametric module 204 may use the parametric model to analyze future behaviors of a component by determining a new input that results in a new output. For example, where the input is (s0, s1) and the output is (s0′, s1′), a functionality (f) of the component is such that (s0′, s1′)=f(s0, s1). If (s0′, s1′) is a desired output, then the corresponding input may be obtained by f¹(s0′, s1′). The parametric module 204 may determine a parametric model to infer the functionality (f). The parametric module 204 may also determine at least one constraint for the parametric model. This constraint depicts the condition under which f represents the functionality of the component.

In some embodiments, the parametric module 204 selects a parametric model from multiple types of parametric models. For example, the types of parametric models may include one or more of a linear regression model, a polynomial regression model, a non-linear regression model, a regular expression model, or an operation sequence based model. The parametric module 204 may select one of the types of parametric models based on a data type associated with a data set. For example, the parametric module 204 may select the regular expression model based on the data type associated with the data set including strings.

The parametric module 204 may generate an initial model to test based on a first data item in the data set. For example, as described in greater detail below with reference to the regular expression model, the parametric module 204 may generate an initial model based on an extraction regular expression generated for a first data item. The parametric module 204 may revise the initial model based on subsequent data items.

The parametric module 204 may analyze data sets with non-primitive data types using a regression model. For example, the data set may include strings. A string may include an array of characters. The parametric module 204 may generate a parametric model that breaks the string into characters, and uses character codes (e.g., integers) to build an integer regression model.

The parametric module 204 may apply a linear regression on the characters in the string. For example, the input (s) for the component may be expressed as s[0], s[1], s[2], etc. and the output (s′) for the component may be expressed as s′[0], s′[1], s′[2], etc. The parametric module 204 may perform linear regression with the following general form to represent a string reverse operation:

s′[s·len−k−1]=s[k] for 0≦k<s·len (1)

The regression model used for strings may also apply to other non-primitive data types including vectors, linked lists, and stacks. However, where the regression model is too restrictive, a more general model, such as the regular expression model may be more effective. The regular expression model relates each output character (c′) with an input string (s) through a regular expression (re). This may be expressed as “c′=extract(s, re).”

A regular expression may include a sequence of characters that may be used to search for matching strings. For example, “[a-z]” represents a letter between “a” and “z”; “[a-zA-Z]” represents any lower or upper case letter and may be abbreviated as “4”; “[0-9]” represents a digit between “0” and “9” and may be abbreviated as “\d”; “(c1|c2)” represents character “c1” or “c2”; “c1*” represents a repeat of character “c1” for zero or more times; “c1+” represents a repeat of character “c1” for one or more times; “c1{n}” represents a repeat of character “c1” for “n” times; and “\w+_[0-9]*” represents any string starting with at least one letter, then with “_”, and that then ends with some digits.

For the regular expression “c′=extract(s, re)” in the table below c′ is the character at the place holder (□) for a first match of a regular expression (re) in the input (s).

TABLE 3
Examples of Regular Expressions

| Input (s) | Regular Expression (re) | Output Character (c′) |
|---|---|---|
| “Abc_Bc” | “Abc_□” | ‘B’ |
| “Abc_Bc” | “A[a-z]+_ □” | ‘B’ |
| “Abc_Bc” | “\w+□[A-Z]” | ‘_’ |
| “a1b2c3” | “\d□\d” | ‘b’ |

If known inputs and corresponding known outputs for a data set are associated with different regular expressions, the parametric module 204 may combine the different regular expressions. The parametric module 204 may generalize the regular expressions and unite the generalized regular expressions to create a single regular expression. For example, a digit joined with a digit may be expressed as “[0-9]”; a lower case letter joined with a lower case letter may be expressed as “[a-z]”; an upper case letter joined with an upper case letter may be expressed as “[A-Z]”; a lower case letter joined with an upper case letter may be expressed as “[a-zA-Z]”, which is also expressed as “\w”; a non-letter character “c1” joined with a non-letter character “c2” may be expressed as “c2=(c1|c2)”; “c*” joined with “c+” may be expressed as “c*”; and “c+” joined with “c+” may be expressed as “c+.” The table below includes some specific examples of a union of different regular expressions (“re1” and “re2”).

TABLE 4
Regular Expressions that Are Generalized and United

| re1 | re2 | re1 union re2 |
|---|---|---|
| a1A | a2A | a[0-9]A |
| A!a | B@f | [A-Z](!1@)[a-z] |
| aab11 | ab | a+b1* |
| a[0-9] | \w123 | \w[0-9]+ |

Below is an example of how the parametric module 204 determines whether a parametric model applies to the data set using a regular expression model for strings. The example assumes this regular expression model:

s′[i]=extract(sⱼ,reᵢ) (2)

where s′ represents output from a component with unknown functionality, i represents a position of a character in output string s′, sⱼ represents the j^{th} input string, and reᵢ represents the extraction regular expression for output character s′[i].

For each data item of the data set from Table 1, the parametric module 204 infers at least one extraction regular expression. The data set includes known inputs and corresponding known outputs. Table 5 represents steps taken by the parametric module 204 to infer the extraction regular expression for the first four data items of Table 1. The first three columns of Table 5 are repeated from Table 1 for the first four data items of the data set. The fourth column represents the first character from the output. The fifth column represents the extraction regular expression for each data output inferred by the parametric module 204.

TABLE 5
Examples of Extraction Regular Expressions

| s0 | s1 | s0′ | s0′[0] | Extraction RE for s0′[0] |
|---|---|---|---|---|
| “AA” | “Abc Bc” | “BA0” | “B” | extract(s1, “Abc □”) |
| “A12 Bcd” | “Ac Bc” | “BA0” | “B” | extract(s0, “A12 □”) [symbol] |
| | | | | extract(s1, “Ac □”) |
| “D Bcd” | “B_C” | “CD0” | “C” | extract(s1, “B_□”) |
| “D_” | “C0” | “CD0” | “C” | extract(s1, “□”) |

The parametric module 204 may build an initial model by determining an extraction regular expression for a first data item in a data set. For example, the parametric module 204 may analyze a first data item with the unanalyzed known inputs “AA” and “Abc Bc” and the corresponding unanalyzed known output “B.” The parametric module 204 identifies the first character in the corresponding unanalyzed known output as “B” and infers that the extraction regular expression for the first data item is “extract(s1, Abc□).”

The parametric module 204 may analyze an unanalyzed known input from a next data item in the data set based on the initial model to determine a predicted output. The parametric module 204 may determine whether the predicted output matches a corresponding unanalyzed known output that corresponds to the unanalyzed known input from the next data item. If the predicted output matches the corresponding unanalyzed known output, the parametric module 204 may determine whether there are additional unanalyzed data items. In this example, if the predicted output matches the corresponding unanalyzed known output for the first data item, the parametric module 204 analyzes a second data item in the data set.

If the predicted output does not match the corresponding unanalyzed known output, the parametric module 204 may determine an error rate between the predicted output and the corresponding unanalyzed known output. If the error rate is low, the parametric module 204 may accept the second data item, update model parameters, and determine whether there are additional unanalyzed data items. The updated model parameters may be stored in the memory 227 as part of the system data 210. In the regular expression model example, if the predicted output does not match the corresponding unanalyzed known output for the first data item, but the error rate is low, the parametric module 204 may update the model parameters by generalizing a first extraction regular expression and uniting the generalized extraction regular expression with a second extraction regular expression that corresponds to the second data item.

The parametric module 204 may determine that the error rate is low if the error rate is less than a given threshold value. Expressed differently, the parametric module 204 may determine whether the error rate exceeds the threshold value and, if so, the parametric module 204 may generalize the initial model or select a new model with new parameters. The threshold value may be specified by a user, data-set dependent, based on a default setting for the test application 106, etc. In some embodiments, the parametric module 204 may determine the threshold value by performing empirical studies.

Continuing with the regular expression model example described above, the first extraction regular expression is “extract(s1, Abc□).” The parametric module 204 determines that the predicted output of using “extract(s1, Abc□)” does not match the corresponding unanalyzed known output “B.” The threshold value in this example is 1. The parametric module 204 determines the error rate based on string distance and determines that the distance between “Ac Bc” and “Abc□” is 3, which exceeds the threshold value of 1. As a result, the parametric module 204 generalizes the extraction regular expression from the first data item “extract(s1, Abc□)” and the extraction regular expression from the second data item “extract(s0, A12□) [symbol] extract(s1, Ac□)” as “extract(s1, Ab*c□).”

The parametric module 204 may continue to refine the initial model by analyzing additional unanalyzed data items from a data set. Continuing with the example above, the parametric module 204 determines that a predicted output for a third data item does not match a corresponding unanalyzed known output of “C.” The parametric module 204 determines that the error rate exceeds the threshold value and, as a result, the parametric module 204 generalizes “extract(s1, “Ab*c□”)” as “extract(s1, “B_□”)” and creates a union between the generalized extraction regular expression and the third data item, which is “extract(s1, “\w+(|_)□”).” As a result, the extraction regular expression for the first character may be expressed as “s0′[0]=extract(s1, “\w+(|_)□”).”

The parametric module 204 may determine whether additional unanalyzed data items from the data set exist. Continuing with the example above, the parametric module 204 determines that the predicted output for the fourth data item does not match the corresponding unanalyzed known output of “C.” The parametric module 204 may determine that the error rate does not exceed the threshold value if the distance between “C0” and “\w+(|_)□” is 1. As a result, the parametric module 204 may accept the data, keep the generalized extraction regular expression, and analyze additional unanalyzed data items from the data set.

After the parametric module 204 analyzes the data items for the first character for the corresponding unanalyzed known output (s0′[0]), the parametric module 204 may analyze the data items for the subsequent character for the corresponding unanalyzed known output. The parametric module 204 may generate a new extraction regular expression for each character position. In the regular expression model example, the extraction regular expression for the second character (s0′[1]) equals “extract(s0, “□”)” and the extraction regular expression for the third character (s0′ [2]) equals “0.”

In some embodiments for the regular expression model where the parametric module 204 determines that an error rate exceeds the threshold value, and the generalization cannot produce a regular expression for all the data items, the parametric module 204 may determine that the initial model does not apply to a current data item. Alternatively or additionally, the parametric module 204 may determine that the initial model may not be capable of being modified (e.g. through generalization) to apply to the unanalyzed data item and, as a result, the parametric module 204 may create a new model with new parameters. In some embodiments, where the initial model applies to some of the data items and the new model applies to other data items, the parametric module 204 may classify the data items into different groups that are associated with the initial model or the new model.

Continuing with the regular expression model example above, the parametric module 204 determines that the extraction regular expression for the first character (s0′ [0]=extract(s1, “\w+(|_)□”)) does not apply to fifth data item “B,” and this regular expression cannot be generalized to apply to the fifth data item. In fact, character “B” may be taken from string “s0” rather than “s1.” As a result, the parametric module 204 groups the first four data items in group 1 and groups the next three data items in group 2.

The parametric module 204 may classify different data items into groups based on the characteristics of the corresponding known outputs. For example, for the regular expression model example, the parametric module 204 may classify the first four data items as group 1 based on the corresponding known outputs including three characters.

Continuing with the example above, the parametric module 204 may determine that the extraction regular expression for the fifth data item is “extract(s0, “a a□”)”, the extraction regular expression for the sixth data item is “extract(s0, “c□”)”, and the extraction regular expression for the seventh data item is “extract(s1, “b□”).” The parametric module 204 generalizes the extraction regular expressions and unites the generalized extraction regular expressions as “s0′[0]=extract(s0, “[a-z] a*□”)” for the group 2 data items.

The parametric module 204 may classify the data items into groups and determine a constraint for each group. The constraint may describe a condition that all inputs satisfy, hence the constraint characterizes the inputs within a group. The parametric module 204 may determine the constraint for each group by creating a union of the known inputs for each character for each group. The parametric module 204 may use the union of the inputs to infer a regular expression that represents a superset of the string data. For example, for the regular expression model example, the union of the input for the first character of the input (s0) for group 1 may include: “AA” ∪ “A 12 Bcd” ∪ “D Bcd” ∪“D_” and the regular expression may include “[A-Z](|_)\w+.” The union of the input for the second character of the input (s1) for group 1 may include “Abc Bc” ∪“Ac Bc” ∪ “ ”B_C” ∪ “C0” and the regular expression may include “[A-Z][a-z]*(0|((|_)[A-Z]c*).” The union of the input for the first character of the input (s0) for group 2 may include “a aB” ∪“c A” ∪ “b C” and the regular expression may include “[a-z] a*[A-Z].” The union of the input for the first character of the input (s1) for group 2 may include “a CDe” ∪“ ”∪“12 D” and the regular expression may include “ . . . ” (any string).

The parametric module 204 may determine a constraint for each group that guards relevant data. The constraint may include one or both of the regular expression that represents the superset of the string data and the regular expression model holds true. An inferred model may include the following equation:

p(s₁) [symbol] . . . [symbol] p(sₙ) [symbol] s′[i]=extract(sⱼ,reᵢ) (3)

Thus, for the regular expression example, a model for group 1 may include “s0.match(“[A-Z](|_)\w+”) [symbol] s0.match(“[A-Z][a-z]*(0|_) [A-Z]c*”)) [symbol] s0′[0]=extracts(s1, “\w+(|_)□”) [symbol] s0′[1]=extracts(s0, “□”) [symbol] s0′[2]=‘0’.” A model for group 2 may include “s0.match(“[a-z] a*[A-Z]”) [symbol] s0′ [0]=extract(s0, “[a-z] a+□”).”

In some embodiments, the linear regression model and the regular expression model may be problematic based on a number of individual variables that are introduced. As a result, the linear regression model and the regular expression model may not be ideal models for some components.

An operation sequence model may be more general than the linear regression model or the regular expression model but less efficient. The operation sequence model may infer an operation sequence that manipulates a known input to generate a corresponding known output. The operation sequence model may work for non-primitive data types, such as strings, pointers, heaps, and user-defined data structures. String operations include, for example, concat, substr, toNum, charAt, valueOf, replace, etc. Table 6 illustrates inputs (original strings) that result in outputs (result strings) based on operations.

TABLE 6
Example String Inputs and Outputs That Are Modified by an Operation

| original s | operations | result s |
|---|---|---|
| “abc” | concat(substr(s, 1), charAt(s, 0)) | “bca” |
| “123” | valueOf(toNum(s) + 3) | “126” |
| “ABA” | replace(s, “A”, charAt(s, 1)) | “BBB” |

The parametric module 204 may generate an operation sequence model using a try-backtrack method. The parametric module 204 may analyze a data set of known inputs and corresponding known outputs by starting with a first unanalyzed data item and identifying a next string operation (op) from the data set. The parametric module 204 may determine whether a corresponding known output string may be obtained by applying an operation to the known input string (e.g., where the known input may include possible symbolic values) by consulting a string solver. If the parametric module 204 identifies an operation that applies to the first data item, the parametric module 204 may proceed to a next data item in the data set and determine whether the operation applies to the data item. The parametric module 204 may continue to perform the analysis for each data item until all the data items in the data set are analyzed.

The following table illustrates inputs (original strings) that result in outputs (result strings) based on operations. With candidate operations such as “concat” and “substr,” the inferred model may include “s′=concat(substr(s,1),s[0])” where numeric numbers “0” and “1” may be identified by a string solver. Essentially, this method enumerates operation combinations and searches a large state space to obtain a valid model.

TABLE 7
Example String Inputs and Outputs That Are Modified by Operations

| Input | Output |
|---|---|
| s | s′ |
| “abc” | “bca” |
| “abcd” | “bcda” |
| “a” | “a” |
| “1234” | “2341” |
| “1” | “1” |

The non-parametric module 206 may generally be configured to determine a relationship between inputs and outputs without using a specific model. The non-parametric module 206 may use a backwards calculation that is directed to satisfy a condition to determine a new input for a new output that obtains a constraint, such as a missed branch, a potential bug, or a security breach. Since the constraint is known, the non-parametric module 206 may use the backwards calculation to determine an unknown input that corresponds to the output. For example, the non-parametric module 206 may use a K-nearest neighbors regression to identify a constraint and determine a new input and a corresponding new output that satisfy the constraint based on one or more data items. In some embodiments, the non-parametric module 206 may determine the relationship between inputs and outputs responsive to the parametric module 204 failing to determine a parametric model that applies to the data set. In some embodiments, the non-parametric module 206 may determine the relationship between inputs and outputs independent of the parametric module 204.

The following is an example of a K-nearest neighbors regression. The non-parametric module 206 may receive a data set that includes known input and corresponding known output associated with a component from the data module 202 or retrieve the data set from the memory 227. The non-parametric module 206 may receive future code and identify a constraint from the future code.

The non-parametric module 206 may identify neighbor data items from the data set for a K number of neighbors based on proximity to a target. Each neighbor data item may include a neighbor input and a corresponding neighbor output. “K” may be specified by a user, set as a default setting for the test application 106, etc. The proximity to the target may be determined as the K number of neighbor outputs that are closest to the target, where the target may satisfy the constraint.

The non-parametric module 206 may average the neighbor inputs that correspond to the K nearest neighbor outputs. The neighbor inputs may include points in a Cartesian coordinate system specified by two- (three-, or more) dimensional coordinate pairs, such as two-dimensional coordinate pairs (1, 10), (2, 19), and (−3, −20). Accordingly, the non-parametric module 206 may average the points by averaging the three x (or first) coordinates of the two-dimensional coordinate pairs and then averaging the three y (or second) coordinates of the two-dimensional coordinate pairs as ((1+2−3)/3, (10+19−20)/3)=(0, 3).

In some embodiments, the non-parametric module 206 may average neighbor inputs where the inputs include non-numeric data. For example, the inputs may include strings. The non-parametric module 206 may identify shared substrings, identify unmatched substrings from the strings as the characters remaining after the shared substrings are removed, and calculate an average of the unmatched substrings. In embodiments where two strings may be averaged, for each unmatched substring pair (t1ε s1, t2ε s2), the non-parametric module 206 may calculate an average substring t using the following equations:

$$len ( t ) = ⌈ \frac{len ( t 1 ) + len ( t 2 )}{2} ⌉ - random \{ 0 , 1 \} \\ ∀ i < len ( t ) \text{:} t [ i ] = \{ \begin{matrix}t 1 [ i ] & if i \geq len ( t 2 ) \\ t 2 [ i ] & if i \geq len ( t 1 ) \\ ⌈ \frac{t 1 [ i ] + t 2 [ i ]}{2} ⌉ & otherwise\end{matrix} \qquad ( 4 )$$

where len represents a length of an average substring, t is the average substring, and i represents a position of a character in the substring.

Table 7 includes examples of string averages where a first column includes a first string (s1), a second column includes a second string (s2), a third column includes a substring shared by the first string and the second string, and a fourth column illustrates averages of the first strings and the second strings.

TABLE 8
Example String Averages

| s1 | s2 | shared | average |
|---|---|---|---|
| “ ” | “a” | “ ” | “a” |
| “abc” | “abc” | “abc” | “abc” |
| “abc” | “abe” | “ab” | “abd” |
| “ab1cd3” | “ab2cd2” | “ab”, “cd” | “ab2cd3” |
| “a” | “abc” | “a” | “ab” |
| “abcd” | “bc” | “bc” | “abc” or “bcd” |

In another embodiment, the non-parametric module 206 may calculate an average of the strings by identifying unmatched substrings as described above, converting each character to a number, for example by mapping each character to a decimal in the ASCII character code, averaging the numbers, converting the average back to a character, and combining the character with the shared substring. For example, using the example from the fourth row of Table 8 where the two strings are “abc” and “abe,” the shared substrings are “ab.” After the shared substrings are removed from each string, the resulting unmatched substring may include “c” and “e.” The non-parametric module 206 may identify that “c” corresponds to 99 in the ASCII character code and “e” corresponds to 101. The average of 99+101/2=100, which corresponds to “d.” The non parametric module 206 may add the shared substring “ab” to the average character “d” to obtain “abd.”

The non-parametric module 206 may use the average as new input, which the non-parametric module 206 uses to calculate a new output. If the new output satisfies the constraint, the non-parametric module 206 may accept the new input and the new output, terminate, or provide the new output to a user. If the new output does not satisfy the constraint, the non-parametric module 206 may add the new input and the new output to the data set and begin another iteration of comparing the new output to neighbor outputs until an updated new output satisfies the constraint or the non-parametric module 206 determines that too many iterations occurred and the non-parametric module 206 terminates. The non-parametric module 206 may transmit the new input and the new output to the data module 202, which updates the data set stored as system data 210 in the memory 227.

The following example includes a component with unknown functionality that generates circles and strings. The data module 202 may receive the data set illustrated in Table 8.

TABLE 9
Data Set for Inputs (i and s) and Outputs (i′ and s′)

| | |
|---|---|
| Input | Output |

| i | s | i′ | s′ |
|---|---|---|---|
| 0.1 | “” | 0.5 | “ab” |
| 0.5 | “a” | 1.4 | “bc” |
| 0.8 | “b” | 1.6 | “bb” |
| 1.2 | “abd” | 3 | “bbb” |
| 1.7 | “” | 4.8 | “b” |
| 2 | “” | 5.6 | “cd” |
| 2.5 | “a” | 2 | “ABC” |
| 2.8 | “b” | 0.4 | “AB” |
| 3.2 | “c” | 1.1 | “B” |
| 3.6 | “ab” | 2.5 | “CD” |
| 1.2 | “ab” | 2.5 | “12” |
| 4.5 | “ac” | 0 | “34” |
| 3.5 | “cd” | 5 | “” |
| 5 | “abc” | 2.9 | “1” |
| 4 | “bacd” | 2 | “” |
| . . . | | . . . | |

The non-parametric module 206 may receive future code that may trigger a security breach if the following constraints are satisfied: “((i−2.4)²+(i′−2.5)²==6.25 && s′.contains(“aa”)).” The non-parametric module 206 may determine that the constraint may include “((i−2.4)²+(i′−2.5)²==6.25” and “s′.contains(“aa”)).”

The non-parametric module 206 may set a number of iterations to one. Tracking the number of iterations may be helpful for determining whether the non-parametric regression may be an incorrect model for the data set. The number of iterations are described in more detail below.

The non-parametric module 206 may receive a value for K where K represents a number of data items that the non-parametric module 206 may use for the K-nearest neighbor regression. K may be specified by a user, part of a default value for the system, dependent on a data type, etc. In some embodiments, K may be changed dynamically. In this example, K is 3.

The non-parametric module 206 may identify data items where a sum of distances of K points to a curve is minimal. In this example, the non-parametric module 206 identifies (0.1, “ ”, 0.5, “ab”); (0.8, “b”, 1.6, “bb”); and (1.2, “abc”, 3, “bbb”) as the data items. The non-parametric module 206 may average the neighbor inputs for the data points. For example, the average i for the neighbor inputs is calculated as i=(0.1+0.8+1.2)/3=0.7. The average s is calculated as “s=average(“ ”, “b”, “abd”)=“ab”.”

The non-parametric module 206 may use the average neighbor input for the data items as a new input to the component with unknown functionality to generate a new output. For example, the new output (i′, s′) is (1.1, “ ”). The non-parametric module 206 may determine whether the new input and the new output satisfy the constraint. For example, the non-parametric module 206 determines that ((0.7−2.4)²+(1.1−2.5)²) does not equal 6.25 and “ ” does not contain “aa”. As a result, the constraint may not be satisfied.

The non-parametric module 206 may add the new input and the new output to the data set and increase the number of iterations by 1. In a next iteration, the non-parametric module 206 may identify data points where a sum of distances of K points to a curve is minimal. In this example, the new input and the new output become part of the neighbor input and neighbor output. Thus, the non-parametric module 206 may identify the neighbor input and neighbor output as (0.7, “ab”, 1.1, “ ”); (0.8, “b”, 1.6, “bb”); and (1.2, “abd”, 3, “bbb”). The non-parametric module 206 may average the neighbor inputs for the data points. For example, the average i for the neighbor inputs is calculated as i=(0.7+0.8+1.2)/3=0.9. The average s is calculated as s=average(“ab”, “b”, “abd”)=“bd”. The non-parametric module 206 may determine that an updated new output (i′, s′) for new input (0.9, “bc”) is (0.5, “aaa”).

The non-parametric module 206 may determine whether the new input and the updated new output satisfy the constraint. For example, the non-parametric module 206 determines that ((0.9−2.4)²+(0.5−2.5)²) does equal 6.25 and “aaa” does contain “aa”. As a result, the new input and the updated new output may be accepted.

FIG. 3 illustrates a flowchart of an example method 300 to test a component with unknown functionality, arranged in accordance with at least one embodiment described herein. The method 300 may be implemented, in whole or in part, by one or more of the test application 106 of FIG. 1 or 2, the device 200 of FIG. 2, or another suitable device, server, and/or system. The test application 106 of FIG. 2 may include a data module 202, a parametric module 204, and a non-parametric module 206. The method 300 may begin at block 302.

In block 302, a data set may be received that includes known inputs and corresponding known outputs associated with a component. For example, the test application 106 of FIG. 1 and/or the data module 202 of FIG. 2 may receive the data set that includes known inputs and corresponding known outputs associated with the component. The component may include unknown functionality. The data set may be stored as system data 210 in the memory 227 of FIG. 2.

In block 304, a parametric model may be generated based on the data set. For example, the test application 106 of FIG. 1 and/or the parametric module 204 of FIG. 2 may generate the parametric model based on the data set. The parametric model may include a regression model, such as a regular expression model, or other type of parametric model.

In block 306, it is determined whether the parametric model applies to the data set. For example, the test application 106 of FIG. 1 and/or the parametric module 204 of FIG. 2 may determine whether the parametric model applies to the data set. If the parametric model applies to the data set (“YES” at block 306), block 306 may be followed by block 308. If the parametric module fails to apply to the data set (“NO” at block 306), block 306 may be followed by block 312.

At block 308, a new output associated with the component may be received. For example, the test application 106 of FIG. 1 and/or the parametric module 204 of FIG. 2 may receive a new output associated with the component. At block 310, a new input may be determined from the new output based on the parametric model. For example, the test application 106 of FIG. 1 and/or the parametric module 204 of FIG. 2 may determine the new input from the new output based on the parametric model.

At block 312, a constraint may be identified. For example, the test application 106 of FIG. 1 and/or the non-parametric module 206 of FIG. 2 may identify the constraint.

At block 314, a new input and a corresponding new output may be determined that satisfy the constraint based on one or more neighbor data items of the data set. For example, the test application 106 of FIG. 1 and/or the non-parametric module 206 of FIG. 2 may determine the new input and the corresponding new output that satisfy the constraint based on the one or more neighbor data items of the data set. The neighbor data items may be data items from the data set that are close to a target that is based on the constraint. Based on determining the new input and the corresponding new output that satisfy the constraint, the test application 106 of FIG. 1 and/or the non-parametric module 206 of FIG. 2 may generate a non-parametric model to automatically determine a functionality of the component.

FIGS. 4A-4B illustrate a flowchart of an example method 400 to generate the parametric model for the component of FIG. 3, arranged in accordance with at least one embodiment described herein. The method 400 may be implemented, in whole or in part, by one or more of the test application 106 of FIG. 1 or 2, the device 200 of FIG. 2, or another suitable device, server, and/or system. The method 400 may begin at block 402.

At block 402, a parametric model may be selected from multiple types of parametric models based on a data type associated with a data set. For example, the test application 106 of FIG. 1 and/or the parametric module 204 of FIG. 2 may select the parametric model from multiple types of parametric models based on the data type associated with the data type. The test application 106 of FIG. 1 and/or the parametric module 204 of FIG. 2 may determine that the multiple types of parametric models include one or more of a linear regression model, a polynomial regression model, a non-linear regression model, a regular expression model, and an operation sequence based model. The test application 106 of FIG. 1 and/or the parametric module 204 of FIG. 2 may select the regular expression model based on the data type including strings, or more generally may select a corresponding one of the models based on a data type of the data set.

At block 404, an initial model may be generated by analyzing a first item in the data set. For example, the test application 106 of FIG. 1 and/or the parametric module 204 of FIG. 2 may generate the initial model by analyzing the first item in the data set. In these and other implementations, generating the initial model by analyzing the first item in the data set may include generating an extraction regular expression based on the first data item, as described above.

At block 406, it is determined whether a next data item from the data set is unanalyzed, where the next data item includes an unanalyzed known input and a corresponding unanalyzed known output. If the next data item from the data set is analyzed (“NO” at block 408), block 406 may be followed by block 408. If the next item from the data set is unanalyzed (“YES” at block 406), block 406 may be followed by block 410.

At block 408, a constraint may be determined for the parametric model. For example, the test application 106 of FIG. 1 and/or the parametric module 204 of FIG. 2 may determine the constraint. The constraint may guard the relevant data. The constraint may be based on the initial model, the new model, or a combination of the initial model and the new model depending on whether a new model was needed, and/or the new model replaced the initial model. For example, where the initial model applies to a first three data items and the new model applies to a next three data items, the test application 106 of FIG. 1 and/or the parametric module 204 of FIG. 2 may determine a first constraint for the initial model and a second constraint for the new model.

At block 410, the unanalyzed known input in the next data item may be analyzed based on the initial model to determine a predicted output. For example, the test application 106 of FIG. 1 and/or the parametric module 204 of FIG. 2 may analyze the unanalyzed known input based on the initial model to determine a predicted output.

At block 412, it is determined whether the predicted output matches the corresponding unanalyzed known output. For example, the test application 106 of FIG. 1 and/or the parametric module 204 of FIG. 2 may determine whether the predicted output matches the corresponding unanalyzed known output. If the predicted output matches the corresponding unanalyzed known output (“YES” at block 412), block 412 may be followed by block 406. If the predicted output fails to match the corresponding unanalyzed known output (“NO” at block 412), block 412 may be followed by block 414.

In some embodiments, responsive to the predicted output failing to match the corresponding unanalyzed known output, the initial model may be generalized. For example, where the parametric model includes the regular expression model, an extraction regular expression for the initial model may be generalized. It may be determined whether the generalized initial model applies to the next data item, and if the generalized initial model fails to apply to the next item, the first data item may be classified as being associated with the initial model. Thus, the first data item may be part of a group 1 and the next data item may be part of a group 2.

At block 414, an error rate between the predicted output and the corresponding unanalyzed known output may be determined. For example, the test application 106 of FIG. 1 and/or the parametric module 204 of FIG. 2 may determine the error rate between the predicted output and the corresponding unanalyzed known output. The error rate may be determined as a cost function based on string distance.

At block 416, it is determined whether the error rate exceeds a threshold value. For example, the test application 106 of FIG. 1 and/or the parametric module 204 of FIG. 2 may determine whether the error rate exceeds a threshold value. If the error rate exceeds the threshold value (“YES” at block 416), block 416 may be followed by block 418. If the error rate is below the threshold value (“NO” at block 416), block 416 may be followed by block 424.

At block 418, it is determined whether the initial model can be generalized to apply to the next data item. For example, For example, the test application 106 of FIG. 1 and/or the parametric module 204 of FIG. 2 may determine whether the current model can be generalized to apply to the next data item. For instance, the regular expression may be generalized to accommodate the next string item. If the initial model cannot be generalized (“NO” at block 418), block 418 may be followed by block 420. If the initial model can be generalized (“YES” at block 418), block 418 may be followed by block 424.

At block 420 a new model may be selected based on the next data item. For example, the test application 106 of FIG. 1 and/or the parametric module 204 of FIG. 2 may select the new model based on the next data item. In some embodiments, the parametric module 204 may select the new model if the initial model may not be modified to apply to the next data item. At block 422, new parameters may be generated for the new model based on the next data item. For example, the test application 106 of FIG. 1 and/or the parametric module 204 of FIG. 2 may generate the new parameters for the new model based on the next data item.

At block 424, model parameters associated with the initial model may be updated to incorporate the unanalyzed known input and the corresponding unanalyzed known output. For example, the test application 106 of FIG. 1 and/or the parametric module 204 of FIG. 2 may update model parameters associated with the initial model to incorporate the unanalyzed known input and the corresponding unanalyzed known output. Block 406 may follow block 424 as unanalyzed data items are analyzed, e.g., according to one or more of blocks 410, 412, 414, 416, 418, 420, 422, and 424, until no unanalyzed data items are remaining and the constraint for the parametric model may be determined.

FIG. 5 illustrates a flowchart of an example method 500 to relate known inputs and corresponding known outputs for the component of FIG. 3 without assuming a specific model, arranged in accordance with at least one embodiment described herein. The method 400 may be implemented, in whole or in part, by one or more of the test application 106 of FIG. 1 or 2, the device 200 of FIG. 2, or another suitable device, server, and/or system. The method 500 may begin at block 502.

At block 502, a number of iterations may be set to 1. For example, the test application 106 of FIG. 1 and/or the non-parametric module 206 of FIG. 2 may set the number of iterations to 1.

At block 504, neighbor data items may be identified based on proximity to a target, where each neighbor data item includes a neighbor input and a corresponding neighbor output. For example, the test application 106 of FIG. 1 and/or the non-parametric module 206 of FIG. 2 may identify the neighbor data items based on proximity to the target. The proximity to the target may be determined as a K number of neighbor outputs that are closest to the target, where the target may satisfy the constraint and K may be defined by a user.

At block 506, a new input may be determined based on averaging the neighbor inputs for the neighbor data items. For example, the test application 106 of FIG. 1 and/or the non-parametric module 206 of FIG. 2 may determine the new input based on averaging the neighbor inputs for the neighbor data items.

At block 508, a corresponding new output may be determined based on the new input. For example, the test application 106 of FIG. 1 and/or the non-parametric module 206 of FIG. 2 may determine the corresponding new output based on the new input. The non-parametric module 206 may determine the corresponding new output by analyzing the new input based on the component.

At block 510, it is determined if the corresponding new output satisfies the constraint. For example, the test application 106 of FIG. 1 and/or the non-parametric module 206 of FIG. 2 may determine if the corresponding new output satisfies the constraint. If the corresponding new output satisfies the constraint (“YES” at block 510), block 510 may be followed by block 512. If the corresponding new output fails to satisfy the constraint (“NO” at block 510), block 510 may be followed by block 514.

At block 512, the new input and the new output may be accepted. For example, the test application 106 of FIG. 1 and/or the non-parametric module 206 of FIG. 2 may accept the new input and the new output.

At block 514, it is determined if the number of iterations exceed a threshold value. For example, the test application 106 of FIG. 1 and/or the non-parametric module 206 of FIG. 2 may determine if the number of iterations exceeds the threshold value. If the number of iterations exceeds the threshold value, (“YES” at block 514), block 514 may be followed by block 516. If the number of iterations is less than the threshold value (“NO” at block 514), block 514 may be followed by block 518. The threshold value may be defined by a user, a default value, etc.

At block 516, the method 500 may stop. For example, the test application 106 of FIG. 1 and/or the non-parametric module 206 of FIG. 2 may stop the method 500. The method 500 may stop if the number of iterations exceeds the threshold value and it may not be possible to determine a relationship between the known inputs and the corresponding known outputs without assuming a specific model. In some embodiments, the test application 106 of FIG. 1 and/or a parametric module 204 of FIG. 2 may generate a parametric model since the non-parametric method failed.

At block 518, the data set may be updated by adding the new input and the corresponding new output to the data set and increasing the number of iterations by 1. For example, the test application 106 of FIG. 1 and/or the non-parametric module 206 of FIG. 2 may update the data set by adding the new input and the corresponding new output to the data set and increasing the number of iterations by 1. Block 518 may be followed by block 504 as the method 500 performs a next iteration with the updated data set. The iterations may continue until the constraint may be satisfied or the number of iterations exceeds the threshold value and the method 500 terminates.

The embodiments described herein may include the use of a special-purpose or general-purpose computer including various computer hardware or software modules, as discussed in greater detail below.

Embodiments described herein may be implemented using computer-readable media for carrying or having computer-executable instructions or data structures stored thereon. Such computer-readable media may include any available media that may be accessed by a general-purpose or special-purpose computer. By way of example, and not limitation, such computer-readable media may include non-transitory computer-readable storage media including random access memory (RAM), read-only memory (ROM), electrically erasable programmable read-only memory (EEPROM), compact disc read-only memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable media.

Computer-executable instructions may include, for example, instructions and data which cause a general-purpose computer, special-purpose computer, or special-purpose processor device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware embodiments configured to perform the operations of the module or component and/or software objects or software routines that may be stored on and/or executed by general-purpose hardware (e.g., computer-readable media, processor devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general-purpose hardware), specific hardware embodiments or a combination of software and specific hardware embodiments are also possible and contemplated. In this description, a “computing entity” may be any computing system as previously defined herein, or any module or combination of modulates running on a computing system.

All examples and conditional language recited herein are intended for pedagogical objects to aid the reader in understanding the invention and the concepts contributed by the inventor to furthering the art, and are to be construed as being without limitation to such specifically recited examples and constraints. Although embodiments of the present inventions have been described in detail, it should be understood that the various changes, substitutions, and alterations could be made hereto without departing from the spirit and scope of the invention.

1. A method to determine a relationship between inputs and outputs based on a parametric model, the method comprising:
receiving a data set that includes known inputs and corresponding known outputs associated with a software component under test and with unknown functionality;
generating, using a processor device programmed to perform or control performance of the generating, a parametric model to automatically determine a functionality of the software component under test based on the data set by selecting the parametric model from multiple types of parametric models based on a data type associated with the data set;
determining whether the parametric model applies to the data set;
responsive to determining that the parametric model applies to the data set, receiving a new output associated with the software component under test; and
determining a new input from the new output based on the parametric model.

2. The method of claim 1, wherein:
the data type includes a non-primitive data type; and
a regression model is selected as the parametric model based on the data type including the non-primitive data type.

3. The method of claim 2, wherein the regression model includes a regular expression model that is configured to identify extraction regular expressions for each known output, unite the extraction regular expressions, and generate a generalized regular expression.

4. The method of claim 2, wherein the regression model includes an operation sequence based model that is configured to determine an operation that causes the known inputs to result in the corresponding known outputs.

5. The method of claim 1, further comprising:
determining whether a next data item from the data set is unanalyzed, the next data item including an unanalyzed known input and a corresponding unanalyzed known output; and
responsive to the next data item from the data set being analyzed, determining a constraint for the parametric model.

6. The method of claim 1, wherein the multiple types of parametric models include one or more of a linear regression model, a polynomial regression model, a non-linear regression model, a regular expression model, or an operation sequence based model.

7. The method of claim 1, further comprising:
generating an initial model for the parametric model by analyzing a first data item in the data set;
determining whether a next data item from the data set is unanalyzed, the next data item including an unanalyzed known input and a corresponding unanalyzed known output;
responsive to the next data item from the data set being unanalyzed, analyzing the unanalyzed known input based on the initial model to determine a predicted output;
determining whether the predicted output matches the corresponding unanalyzed known output; and
responsive to the predicted output matching the corresponding unanalyzed known output, determining whether another data item from the data set is unanalyzed.

8. The method of claim 7, further comprising:
responsive to the predicted output failing to match the corresponding unanalyzed known output, determining an error rate between the predicted output and the corresponding unanalyzed known output;
determining whether the error rate exceeds a threshold value;
responsive to the error rate failing to exceed the threshold value, determining whether the initial model can be generalized to apply to the next data item;
responsive to the initial model being capable of being generalized to apply to the next data item, updating model parameters associated with the initial model to incorporate the unanalyzed known input and the corresponding unanalyzed known output; and
determining whether another data item from the data set is unanalyzed.

9. The method of claim 8, further comprising:
responsive to the error rate exceeding the threshold value, selecting a new model based on the next data item;
generating new parameters for the new model based on the next data item; and
determining whether another data item from the data set is unanalyzed.

10. The method of claim 9, further comprising:
responsive to the predicted output failing to match the corresponding unanalyzed known output, generalizing the initial model;
determining whether the generalized initial model applies to the next data item;
responsive to the generalized initial model failing to apply to the next item, classifying the first data item as being associated with the initial model; and
classifying the next data item as being associated with the new model.

11. A method to relate inputs and outputs without assuming a specific model, the method comprising:
receiving a data set that includes known inputs and corresponding known outputs associated with a software component under test and with unknown functionality;
identifying a constraint;
identifying neighbor data items based on proximity to a target, wherein each neighbor data item includes a neighbor input and a corresponding neighbor output;
determining a new input based on averaging neighbor inputs for the neighbor data items;
determining a corresponding new output based on the new input;
determining whether the corresponding new output satisfies the constraint; and
generating, using a processor device programmed to perform or control performance of the generating, a non-parametric model to automatically determine a functionality of the software component under test.

12. The method of claim 11, further comprising:
setting a number of iterations to 1;
responsive to the corresponding new output failing to satisfy the constraint, determining whether the number of iterations exceed a threshold value; and
responsive to the number of iterations failing to exceed the threshold value, updating the data set by adding the new input and the corresponding new output to the data set and increasing the number of iterations by one.

13. The method of claim 12, further comprising responsive to the number of iterations exceeding the threshold value generating a parametric model.

14. A method to analyze code whose functionality is unknown, the method comprising:
receiving a data set that includes known inputs and corresponding known outputs associated with a software component under test and with unknown functionality;
generating, using a processor device programmed to perform or control performance of the generating, a parametric model based on the data set;
determining whether the parametric model applies to the data set;
responsive to the parametric model failing to apply to the data set, identifying a constraint;
determining a new input and a corresponding new output that satisfy the constraint based on one or more data items of the data set; and
generating a non-parametric model to automatically determine a functionality of the software component under test.

15. The method of claim 14, further comprising:
responsive to the parametric model applying to the data set, receiving a new output associated with the software component under test; and
determining a new input from the new output based on the parametric model.

16. The method of claim 15, wherein generating the parametric model based on the data set comprises:
generating an initial model by applying a first item in the data set;
determining whether a next data item from the data set is unanalyzed, the next data item including an unanalyzed known input and a corresponding unanalyzed known output; and
responsive to the next data item from the data set being unanalyzed, analyzing the unanalyzed known input based on the initial model to determine a predicted output.

17. The method of claim 16, further comprising:
determining whether the predicted output matches a corresponding unanalyzed known output; and
responsive to the predicted output failing to match the corresponding unanalyzed known output, determining an error rate between the predicted output and the corresponding unanalyzed known output;
determining whether the error rate exceeds a threshold value;
responsive to the error rate failing to exceed the threshold value, updating model parameters associated with the initial model to incorporate the unanalyzed known input and the corresponding unanalyzed known output; and
determining whether another data item that is part of the data set is unanalyzed.

18. The method of claim 17, further comprising:
responsive to the error rate exceeding the threshold value, selecting a new model based on the next data item;
generating new parameters for the new model based on the next data item; and
determining whether another data item that is part of the data set is unanalyzed.

19. The method of claim 14, wherein determining the new input and the corresponding new output that satisfy the constraint based on one or more data items of the data set comprises:
identifying neighbor data items based on proximity to a target, where each neighbor data item includes a neighbor input and a corresponding neighbor output;
determining the new input based on averaging neighbor inputs for the neighbor data items;
determining the corresponding new output based on the new input; and
determining whether the corresponding new output matches the constraint.

20. The method of claim 19, further comprising:
setting a number of iterations to 1;
wherein responsive to the corresponding new output failing to satisfy the constraint, determining whether the number of iterations exceeds a threshold value.
